(19) United States
(12) Patent Application Publication
(10) Pub. No.: US 2025/0313127 A1
(43) Pub. Date: Oct. 9, 2025

(54) Method for Controlling Battery and a Mobility Apparatus Implementing the Same

(71) Applicants: Hyundai Motor Company, Seoul (KR); Kia Corporation, Seoul (KR)

(72) Inventor: Won Jae Lee, Hwaseong-Si (KR)

(21) Appl. No.: 18/965,891

(22) Filed: Dec. 2, 2024

(30) Foreign Application Priority Data
Apr. 8, 2024 (KR) 10-2024-0047483

(51) Int. Cl. B60L 58/18; B60L 7/18

(52) U.S. Cl. CPC B60L 58/18; B60L 7/18; B60L 2240/547; B60L 2260/20

(57) ABSTRACT

A method performed by an apparatus of a vehicle may include: selecting, by a controller of the vehicle, a driving mode, among a plurality of driving modes, for the vehicle; based on an operational characteristic of a driving motor of the vehicle and based on the selected driving mode, selecting a battery between a first battery of the vehicle and a second battery of the vehicle; and controlling, by the controller, the selected battery to supply power to the driving motor. The driving motor may supply a driving force to a plurality of wheels of the vehicle.

### CROSS-REFERENCE TO RELATED APPLICATION

The present application claims priority to Korean Patent Application No. 10-2024-0047483, filed on Apr. 8, 2024, the entire contents of which are incorporated herein by reference for all purposes.

### TECHNICAL FIELD

The present disclosure relates to a method for controlling a battery and a mobility apparatus implementing the same.

### BACKGROUND

In general, an electric vehicle is operated with wheels driven by the driving force of a driving motor. For example, a fixed-type high-voltage battery may be mounted on a vehicle to supply power to a driving motor. The driving motor may be an alternating current (AC) motor, and an inverter may be connected between the battery and the driving motor.

According to a charging status, also referred to as a state of charge (SOC), when charging is required, the battery of the electric vehicle may be charged by receiving external power through an onboard charger (OBC). A charging time may be determined according to charging methods, including, for example, slow charging and fast charging.

With the continuing research and development on battery technologies, the range of the vehicle, also expressed as the driving distance per charge, has greatly improved in recent years. However, the fixed-type battery that is mounted on a semi-permanent basis on the electric vehicle may pose various challenges and disadvantages.

### SUMMARY

The present disclosure is provided to alleviate or solve problems observed in some implementations.

The present disclosure provides an efficient operation strategy for a dual battery system based on an operation point of a driving motor.

One or more example embodiments of the present disclosure are provided to a new concept of technology that uses a second high-voltage battery added to or detached from the power system of an electric vehicle when necessary in addition to a first high-voltage battery preset in the electric vehicle.

According to one or more example embodiments of the present disclosure, a method performed by an apparatus of a vehicle may include: selecting, by a controller of the vehicle, a driving mode, among a plurality of driving modes, for the vehicle; based on an operational characteristic of a driving motor of the vehicle and based on the selected driving mode, selecting a battery between a first battery of the vehicle and a second battery of the vehicle; and controlling, by the controller, the selected battery to supply power to the driving motor. The driving motor may supply a driving force to a plurality of wheels of the vehicle

The operational characteristic of the driving motor may map to an area, of a plurality of areas, on a torque-to-revolutions per minute (RPM) map associated with the driving motor. Selecting the battery may include: selecting the battery based on the area to which the operational characteristic of the driving motor is mapped on the torque-to-RPM map.

The plurality of areas on the torque-to-RPM map may be set based on at least one of an equal output reference line, an equal accelerator pedal sensor (APS) reference line, or an RPM reference line.

The equal output reference line may be set based on efficiency of a lower voltage battery of the first battery and the second battery.

The RPM reference line may be based on a boundary between an equal torque section in the torque-to-RPM map and an equal output section in the torque-to-RPM map.

The plurality of areas on the torque-to-RPM map may include at least two or more of: a first area associated with RPM values below the RPM reference line and torque values below the equal APS reference line, a second area associated with torque values above the equal APS reference line and below the equal output reference line and a maximum torque line, a third area associated with torque values above the equal output reference line, and a fourth area associated with RPM values above the RPM reference line and torque values below the equal output reference line.

The plurality of driving modes may include a first driving mode and a second driving mode. Selecting the battery may further include one of: based on the operational characteristic being associated with the second area on the torque-to-RPM map, and based on the selected driving mode being the first driving mode, selecting the battery by selecting a lower voltage battery of the first battery and the second battery; based on the operational characteristic being associated with the second area on the torque-to-RPM map, and based on the selected driving mode being the second driving mode, selecting the battery by selecting a higher voltage battery of the first battery and the second battery; based on the operational characteristic being associated with the fourth area on the torque-to-RPM map, and based on the selected driving mode being the first driving mode, selecting the battery by selecting a higher voltage battery of the first battery and the second battery; or based on the operational characteristic being associated with the fourth area on the torque-to-RPM map, and based on the selected driving mode being the second driving mode, selecting the battery by selecting a lower voltage battery of the first battery and the second battery.

The plurality of driving modes may include a first driving mode and a second driving mode. Selecting the battery may further include at least one of: based on the operational characteristic being associated with the first area on the torque-to-RPM map, selecting the battery by selecting a lower voltage battery of the first battery and the second battery; or based on the operational characteristic being associated with the third area on the torque-to-RPM map, selecting the battery by selecting a higher voltage battery of the first battery and the second battery.

The plurality of driving modes may include a low-output mode and a high-torque mode.

The low-output mode may include at least one of a normal mode, a comfort mode, or an eco mode. The high-torque mode may include at least one of a sports mode or a track mode.

Selecting the driving mode may include at least one of: selecting, between a first driving mode and a second driving mode, a default driving mode; based on the operational characteristic changing from being associated with the second area to being associated with the third area, selecting the second driving mode; based on the operational characteristic changing from being associated with the third area to being associated with the second area, selecting the second driving mode; based on the operational characteristic changing from being associated with the second area to being associated with the first area, selecting the first driving mode; or based on the operational characteristic being associated with the second area for longer than a threshold time duration, selecting the second driving mode.

Selecting the driving mode may include: selecting, based on a location of the vehicle, one of a first driving mode or a second driving mode.

Selecting the driving mode may further include: based on the location being a mountain road, selecting the second driving mode; and based on the location being at least one of a city road, or a highway, selecting the first driving mode.

Selecting the driving mode may include: selecting, based on a transporting load of the vehicle, one of a first driving mode or a second driving mode.

Selecting the driving mode may further include: based on the vehicle towing a second vehicle and the transporting load being greater than or equal to a threshold value, selecting the second driving mode.

Selecting the driving mode may include: selecting the driving mode based on a user input of a driver of the vehicle.

Selecting the battery may include: determining that the second battery is detachably connected to a power system of the vehicle, the power system including the first battery.

The driving motor may be configured to generate a regenerative braking power. The method may further include controlling the vehicle to charge the selected battery with the regenerative braking power.

According to one or more example embodiments of the present disclosure, a vehicle may include: a plurality of wheels; a driving motor configured to drive the plurality of wheels; and a controller. The controller may include: memory storing instructions; and one or more processors configured to execute the instructions. The instructions, when executed by the one or more processors, may cause the controller to: select, among a plurality of driving modes, a driving mode for the vehicle; based on an operational characteristic of the driving motor and based on the selected driving mode, select, between a first battery and a second battery, a battery; and control the selected battery to supply power to the driving motor.

The second battery may be detachably connected to a power system of the vehicle. The instructions, when executed by the one or more processors, may further cause the controller to select the battery by selecting the battery after determining that the second battery is connected to the power system. The power system may include the first battery.

The present disclosure is provided to improve energy efficiency through an efficient use strategy of a dual battery according to an operation point of a driving motor and a driving mode of a vehicle.

System efficiency may be improved and power loss may be reduced by separating two battery use areas according to a voltage in a way to minimize the amount of current used.

In addition, the driving distance may be increased and the usability may be improved by detachably connecting a second high-voltage battery to the power system of an electric vehicle.

### BRIEF DESCRIPTION OF DRAWINGS

FIG. 1 is an exemplary view illustrating a power system of a first mobility;

FIG. 2 is a view illustrating that a first mobility is connected to a second mobility;

FIG. 3 is a view illustrating a control process;

FIG. 4 is an exemplary view illustrating specifications of a first high-voltage battery and a second high-voltage battery;

FIG. 5 is an exemplary view illustrating division of a plurality of operation areas in a torque-revolutions per minute (RPM) map; and

FIG. 6 is a view illustrating a control simulation.

### DETAILED DESCRIPTION

While one or more example embodiments are described with reference to the accompanying drawings, it should be understood that various changes and modifications may be made in the present disclosure. Further, it should be understood that the present disclosure is not limited to the specific example embodiments thereof, and various changes, equivalences, and substitutions may be made without departing from the scope and spirit of the disclosure.

In the one or more example embodiments of the present disclosure, terms such as “module”, “unit”, “part”, and the like are terms used for nominal distinct between components, and it should not be interpreted as assuming that they are physically and chemically separated or capable of being separated or divided. Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

Terms containing ordinal numbers, such as “first”, “second”, etc., may be used to describe various components, but the components are not limited by the terms. These terms may be used only in a nominal sense to differentiate one component from another component, and their mutual sequential meaning will be understood through the context of the corresponding description, not through such terms.

For purposes of this application and the claims, the term “and/or” is used to include all instances of any combination of multiple items being the subject. For example, “A and/or B” includes all three cases: “A”, “B”, and “A and B”. Using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

When a component is used to be “coupled” or “connected” to another component, it will be understood that the component may be either connected directly to another component, or connected indirectly via another medium.

The terms in the present application are used to describe an example embodiments and do not intend to restrict and/or limit the present disclosure. Singular forms are intended to include plural forms unless the context clearly indicates otherwise. Terms such as “comprise” or “consist of” are used to designate presence of characteristics, numbers, steps, operations, elements, components or a combination thereof, and do not foreclose the presence or possibility of addition of one or more other characteristics, numbers, steps, operations, elements, components or a combination thereof.

Unless otherwise defined, all terms used in the present disclosure including technical or scientific terms, have the same meaning as generally understood by an ordinary person skilled in the technical field to which the present disclosure pertains. Terms defined in commonly used dictionaries will be interpreted as having a meaning consistent with the meaning in the context of the related technology, and unless clearly defined in this application, should not be interpreted in an ideal or excessively formal sense.

In addition, the terms “unit”, “control unit”, “control device”, or “controller” are only widely used for names of devices that control the corresponding functions, and are not construed as being generic functional units. For example, devices using the terms may include a communication device that communicates with another controller or sensor to control the corresponding function, a computer-readable recording media that stores operating systems, logic commands, input/output information, etc., and at least one or more of processor that performs determination, calculation, decision, etc. used to control the corresponding function.

A processor may include a semiconductor integrated circuit and/or electronic elements that perform at least one or more of comparison, determination, calculation, and decision to achieve a programmed function. For example, the processor may be one or the combination of a computer, a microprocessor, a central processing unit (CPU), an application-specific integrated circuit (ASIC), and electronic circuits (circuitry, logic circuits).

A computer-readable recording medium (or referred to as memory) includes all types of storage devices that store data that is read by a computer system. Examples of the computer-readable recording medium may include at least one a memory of flash memory type, hard disk type, micro type, and card type (e.g. Secure Digital Card (SD Card) or eXtream Digital Card (XD Card)), and a memory of random-access memory (RAM), static RAM (SRAM), read-only memory (ROM), programmable ROM (PROM), electrically erasable PROM (EEPROM), and magnetic RAM (MRAM), a magnetic disk, and an optical disk type.

The term “mobility” or “mobility apparatus” as used herein may refer to any device, apparatus, or machine that is capable of self-propulsion, movement, steering, accelerating, braking, etc. A mobility may be a vehicle, such as an electric vehicle, an internal-combustion engine vehicle, a fuel-cell vehicle, a hybrid vehicle, etc.

Such recording medium may be electrically connected to the processor, and the processor may load and record data from the recording medium. The recording medium and processor may be integrated or may be physically separated.

One or more example embodiments of the present disclosure will be explained with reference to the drawings.

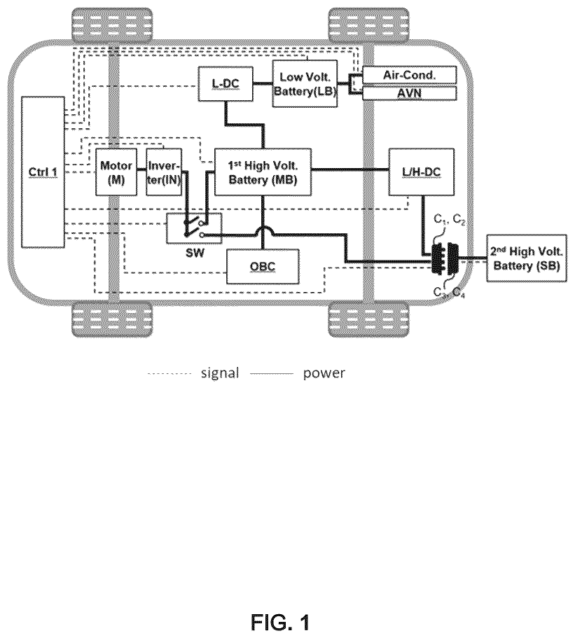

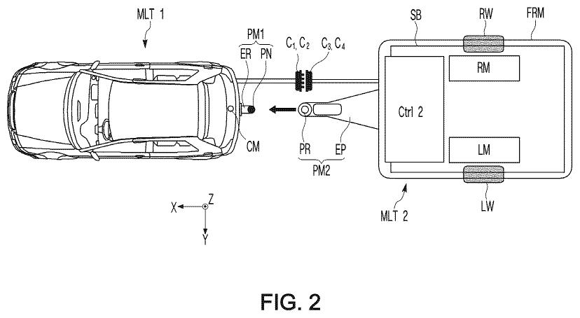

FIG. 1 is a schematic view illustrating a power system of a first mobility MLT 1 (e.g., an electric vehicle), and FIG. 2 is a view illustrating that a second mobility MLT 2 is connected to the first mobility MLT 1.

Referring to FIGS. 1 and 2, the respective structures of the first mobility MLT 1 and the second mobility MLT 2 will be described.

Referring to FIG. 1, the first mobility MLT 1 may be, for example, an electric vehicle, including a first driving motor M, an inverter IN, a first high-voltage battery MB, an on-board charger OBC, a first direct current to direct current (DC/DC) converter L-DC, a low-voltage battery LB, air conditioning equipment Air-cond that operates at a low-voltage, an audio video navigation AVN, a second DC/DC converter L/H-DC, a switch SW, and a controller (referred to as a first controller).

The first driving motor M may provide a driving force to the wheels of the vehicle, and the first driving motor M may be an alternating current motor.

The inverter IN may invert a direct current power supplied to the first driving motor M to an alternating current.

The first high-voltage battery MB may be fixedly provided in the body of the first mobility MLT 1, for example, under the bottom of a vehicle cabin.

The first high-voltage battery MB may mainly supply electric power to the first driving motor M, and may be charged with the onboard charger OBC.

The first high-voltage battery MB may be connected to the low-voltage battery LB through the first DC/DC converter L-DC to charge the low-voltage battery LB.

The first DC/DC converter L-DC may be a step-down DC/DC converter (LDC; low-voltage DC-DC converter) to charge the low-voltage battery LB.

The low-voltage battery LB may be, for example, a battery of 12V or 24V, and may supply electric power to electric devices in the vehicle such as the air conditioning equipment, the AVN, etc. that operate at a low voltage.

The second high-voltage battery SB in FIG. 1 may be provided in the second mobility MLT 2 and mechanically connected through the connection mechanism described below, but the present disclosure is not limited thereto. For example, the second high-voltage battery SB may be mechanically connected as being detachably placed in the first mobility. In other words, the second high-voltage battery SB may be swapped in and out of the first mobility, for example, by a user of the first mobility.

The second high-voltage battery SB may be electrically connected in a wired method (or in a wireless method in a range possible) to the vehicle power system including the first high-voltage battery MB as an additional in a way that the second high-voltage battery SB may not affect the operation of the power system (power supply to vehicle electronics, a driving motor, etc.)

The second high-voltage battery SB may be a replaceable battery, an auxiliary battery, an extended battery, or a secondary battery, but this is only for distinction from the first high-voltage battery MB. The second high-voltage battery SB may not be limited by the name with functions, characteristics, relationships with other objects (the first high-voltage battery MB, a host vehicle, etc.), or its own mechanical/electrical/chemical structure, battery type (types of packaging method, anode material/cathode material/separator material, etc.), charging method, etc.

The second high-voltage battery SB may be connected by wire or wirelessly with the first controller Ctrl 1 of the first mobility MLT 1, or a battery management system (BMS) of the first high-voltage battery MB, and various sensing information (e.g., voltage, current, temperature, etc.) related to the SoC state, physical/electrical/chemical status of the second high-voltage battery SB may be transmitted to the first controller Ctrl 1. However, the present disclosure is not limited thereto, but the information on the second high-voltage battery SB may be transmitted to the first controller Ctrl 1 through a second controller Ctrl 2 of the second mobility MLT 2.

A high-voltage battery applied to the first high-voltage battery MB and the second high-voltage battery SB may include, for example, a plurality of battery cells (not shown) that output a voltage of 2.7 to 4.2 V, and the plurality of battery cells may be connected in series/parallel to each other in a preset number to form a single module. The high-voltage battery may be packaged in one battery package with one or more battery modules connected in series/parallel to output a desired output voltage, for example, approximately 400 V, 800 V, or several kV.

The first high-voltage battery MB and the second high-voltage battery SB each may include the battery management system (BMS).

The BMS may include a battery management unit (BMU), a cell monitoring unit (CMU), and a battery junction box (BJB).

The BMS may perform a cell balancing function to ensure the performance of the entire battery pack by constantly maintaining the voltage of each cell, a State of Charge (SoC) function to calculate the capacity of the entire battery system, battery cooling, charging, discharging control, etc.

The BMU may receive information on all cells from the CMU and perform the functions of the BMS based on the information.

The BMU may consist of, for example, two (2) micro-control units MCU, and each MCU may include a single CAN communication port. The MCU may include a CAN interface to communicate with a vehicle controller which is the upper-level device of the BMS, and a CAN interface for collecting the information of the CMU which is the lower-level device.

The CMU may be directly attached to a battery cell to perform sensing of voltage, current, temperature, etc. The CMU may not perform calculations related to BMS algorithms but may perform sensing. A plurality of battery cells may be connected to a single CMU, and information on each cell may be transmitted to the BMU through the CAN interface.

The BJB may be a pack-level detection mechanism of the BMS and a connection medium between a high-voltage battery and a drivetrain. The BJB may measure and record a battery voltage and a current flowing inside and outside the battery to accurately calculate the SoC. The BJB may perform important functions to safety such as overcurrent detection, insulating monitoring, etc.

The second high-voltage battery SB may be a high-voltage battery lower than the first high-voltage battery MB, and the second DC/DC converter L/H-DC may be a step-up DC/DC converter. The second high-voltage battery SB may be a high-voltage battery higher than the first high-voltage battery MB, and the second DC/DC converter L/H-DC may be a step-down DC/DC converter. The second DC/DC converter L/H-DC may be bidirectional. Therefore, the first high-voltage battery MB and the second high-voltage battery SB may charge and discharge each other.

The second DC/DC converter L/H-DC may be built in the first mobility MLT 1 in the power system but the present disclosure is not limited thereto. For example, at least in some embodiments, the second DC/DC converter L/H-DC may be provided as a separate component and additionally and detachably connected to the power system. The second DC/DC converter L/H-DC may be built in or detachably placed in the second mobility MLT 2.

The second DC/DC converter L/H-DC may not be included. In this case, the first high-voltage battery MB and the second high-voltage battery SB may not charge and discharge each other.

For the detachable electrical connection of the second high-voltage battery SB to the power system, the power system of the first mobility MLT 1 may include first and second connectors C1 and C2, and the second high-voltage battery SB may include third and fourth connectors C3 and C4.

For example, the first and second connectors C1 and C2 may be connectors in an integrated form, and the third and fourth connectors C3 and C4 also may be connectors in an integrated form.

The first connector C1 may be connected to the second DC/DC converter L/H-DC, and the second connector C2 may be connected to the switch SW.

Although not shown, a signal transmission connector may be added to transmit sensing and status information on the second high-voltage battery SB to the controller.

The switch SW may be fixedly and electrically connected to the inverter IN, and switched between the first high-voltage battery MB and the second connector C2 to connect the first high-voltage battery MB to the inverter IN or electrically connect the inverter IN to the second high-voltage battery SB.

The first controller Ctrl 1 may be a vehicle controller of the highest level to control all electrical devices in the first mobility MLT 1, but the present disclosure is not limited thereto. For example, the first controller Ctrl 1 in FIG. 1 may be a power controller of the lower level from the vehicle controller.

The first controller Ctrl 1 may include a computer-readable recording medium that stores an operating system, logic commands, input/output information, etc., and one or more processors that read the information to perform judgments, calculations, decisions, etc.

The second high-voltage battery SB in FIG. 1 may be provided in the second mobility MLT 2 as shown in FIG. 2.

The second mobility MLT 2 may include a frame FRM, a second left-wheel LW placed on the left of the frame FRM, a second right-wheel RW placed on the right of the frame FRM, a second left-driving motor LM for providing a driving force to the second left-wheel LW, a second right-driving motor RM for providing a driving force to the second right-wheel RW, and a second controller Ctrl 2.

The second high-voltage battery SB may be fixedly provided in the second mobility MLT 2, but the present disclosure is not limited thereto. The second high-voltage battery SB may be a fixed-type battery. A fixed-type battery may be attached to a mobility on a permanent basis (e.g., not to be detached from the mobility throughout the expected lifetime of the mobility) or semi-permanent basis (e.g., not to be detached from the mobility throughout the expected lifetime of the mobility except when the battery is to be serviced by authorized personnel such as a mechanic). On the contrary, a detachably connected battery (also referred to as a detachable-type battery, a detachable battery, or a swappable battery) may be a battery that can be relatively easily detached and reattached to a mobility. One or more detachably connected batteries may be attached, detached, and/or reattached with the mobility multiple times throughout the expected lifetime of the mobility. The detachably connected battery may be easier to replace than a fixed-type batter and may even be replaceable by a user of the vehicle. The second high-voltage battery SB may be detachably placed in the second mobility MLT 2. The second high-voltage battery SB mounted in the frame FRM with a fully-discharged SoC status may be removed, and replaced with a new second high-voltage battery SB with a full-charged SoC status.

If the second high-voltage battery SB is fixedly mounted in the second mobility MLT 2, the second mobility MLT 2 may include a charging connector for charging the second high-voltage battery SB.

The frame FRM may form the exterior of the second mobility MLT 2 and accommodate other components.

The frame FRM may include a second pivot mechanism PM2 as a second connection mechanism, and the second pivot mechanism PM2 may be detachably pivot-connected to a first pivot mechanism PM1 which is a first connection mechanism fixed to the body of the first mobility MLT1.

The first pivot mechanism PM1 may include an extension rod ER extending from the body of the first mobility MLT 1 rearwardly, and a pivot pin PN upwardly protruding from the end of the extension rod ER.

The second pivot mechanism PM2 may include an extension unit EP in a triangle shape, which is straightforwardly protruding from the frame FRM of the second mobility MLT 2, and a pivot ring PR into which the pivot pin PN is rotatably inserted from the end of the extension unit EP.

The pivot pin PN may be limited in linear movement while being inserted into the pivot ring PR, but may rotate with respect to a Z-axis direction in FIG. 2. Therefore, while being pivot-connected, the second mobility MLT 2 may be limited in linear movement with regard to the first mobility MLT 1 based on the pivot connection point, but may rotate with respect to the z-axis.

When driving in the forward direction, i.e. in the X-axis direction, the first mobility MLT 1 and the second MLT 2 may maintain straight driving without separate steering control for the second mobility MLT 2.

First and second connection mechanisms may be a pivot mechanism, but the present disclosure is not limited thereto. For example, the first and second mechanisms may be known mechanisms that implements a non-rotational connection with respect to the Z-axis.

The second left-driving motor LM may include a rotational axis connected to the second left-wheel LW to provide a driving force to the second left-wheel LW.

The second right-driving motor RM may include a rotational axis connected to the second right-wheel RW to provide a driving force to the second right-wheel RW.

The second left-wheel LW and the second right-wheel RW may be respectively connected to the second left-driving motor LM and the second right-driving motor RM, thereby enabling independent driving from each other.

The second left-driving motor LM and the second right-driving motor RM may drive in the forward direction and in the reverse direction, respectively. When driven in the forward direction, the second mobility MLT 2 may travel in the forward direction, and when driven in the reverse direction, the second mobility MLT 2 may travel in the rear direction.

For example, the second left-driving motor LM and the second right-driving motor RM each may be implemented in an in-wheel driving system where each driving motor is provided in wheels, but the present disclosure is not limited thereto.

The second mobility MLT 2 may not operate independently on the left and right, but the driving force of a single common motor may be delivered into the second left-wheel LW and the second right-wheel RW. For this, a vehicle gear may be included between the common second driving motor, the second left-wheel LW, and the second right-wheel RW. The driving force of the second driving motor may be divided by the vehicle gear and transmitted to the second left-wheel LW and the second right-wheel RW. A toque vectoring means may be added for torque distribution between the second left-wheel LW and the second right-wheel RW.

Referring to FIG. 2, the second controller Ctrl 2 may control the second left-driving motor LM and the second right-driving motor RM to achieve forward driving and reverse driving of the second mobility MLT 2. The second controller Ctrl2, when the steering of the second mobility MLT 2 is needed, may change the driving direction of the second mobility MLT 2 by controlling respective toques or the rotation numbers of the second left-driving motor LM and the second right-driving motor RM. Through the independent control of driving of the second left-driving motor LM and the second right-driving motor RM, the steering of the second mobility MLT2 may be ensured without a separate steering device.

Wired and wireless communication means may be included to deliver information between connectors in FIG. 1, the first mobility MLT 1, and the second mobility MLT 2.

The first controller Ctrl 1 or the second controller Ctrl 2 may include a memory and a processor. The memory may store computer commanders for performing the functions of the controller, and the processor may perform the functions by loading and executing the commands from the memory.

The memory may include at least one of hard disk drive (HDD), solid-state drive (SDD), silicon disk drive (SDD), ROM, RAM, CD-ROM, magnetic tape, floppy disk, and optical data storage device.

The processor may include at least one of a computer, a microprocessor, a CPU, an ASIC, an electric circuit, and a logic circuit.

The first connector C1 and the second connector C2 of the first mobility MLT1 may be connected to the third connector C3 and the fourth connector C4 of the second mobility MLT2. As a signal transmission connector is connected, the first mobility MLT 1 and the second mobility MLT 2, i.e. the first controller Ctrl 1 and the second controller Ctrl2 may communicate with each other.

If the first mobility MLT 1 and the second mobility MLT 2 are mechanically and electrically connected, and the first mobility MLT 1 starts the forward driving, the second controller Ctrl 2 may perform the straightforward driving of the second mobility MLT 2 by controlling the second left-driving motor LM and the second right-driving motor RM according to the signal received from the first connector C1.

Part or all of the speed, gear position, steering angle, accelerator pedal sensor (APS) information, and brake pedal sensor (BPS) information of the first mobility MLT 1 may be transmitted to the second mobility MLT 2.

The second controller Ctrl 2 of the second mobility MLT 2 may determine whether the first mobility MLT 1 operates in the forward direction or in the reverse direction by using part or all of the speed, the gear position, the APS information, and the BPS information of the first mobility MLT 1. However, the present disclosure is not limited thereto, but it may be possible to directly receive information on whether the first mobility operates in the forward direction or in the reverse direction from the first controller Ctrl 1.

If the first mobility MLT 1 operates in the forward direction, the second controller Ctrl 2 may drive the second left-driving motor LM and the second right-driving motor RM in the forward direction to allow the second mobility MLT 2 to operate in the straightforward direction. If the first mobility MLT 1 operates in the reverse direction, the second controller Ctrl 2 may operate the second left-driving motor LM and the second right-driving motor RM in the reverse direction to allow the rear-driving of the second mobility MLT2.

The second controller Ctrl 2 may determine the steering status based on steering angle information on the first mobility MLT 1 and perform the steering of the second mobility MLT 2 accordingly.

The second mobility MLT 2 may not include a separate steering device such as a steering wheel, a steering rack, etc., but may perform the steering through torque control of the second left-driving motor LM and second right-driving motor RM.

The second controller Ctrl 2 may calculate a driving torque for driving and a steering torque for steering for each of the second left-driving motor LM and the second right-driving motor RM to use for control.

For example, for the steering of the second mobility MLT 2, the steering torque value of the second left-driving motor LM and the second right-driving motor RM according to the steering angle of the first mobility MLT 1 may be included in a look-up table or a calculation program.

While driving in a straightforward direction, the speed of the second mobility MLT 2 may be controlled not to exceed the speed of the first mobility MLT 1. The pivot connection between the first mobility MLT 1 and the second mobility MLT 2 may be within a predetermined pivot angle. For example, while driving in the straightforward direction, if the speed of the second mobility MLT 2 is equal to or smaller than the speed of the first mobility MLT 1, the pivot angle of the second mobility MLT 2 with respect to the first mobility MLT 1 from the pivot connection point may be 0 degrees (an angle at which the first mobility MLT 1 and the second mobility MLT 2 are in a straight line).

While driving in the forward direction, the second mobility MLT 2 may be controlled to follow the first mobility MLT 1, thereby achieving continued and smooth driving of a plurality of mobilities.

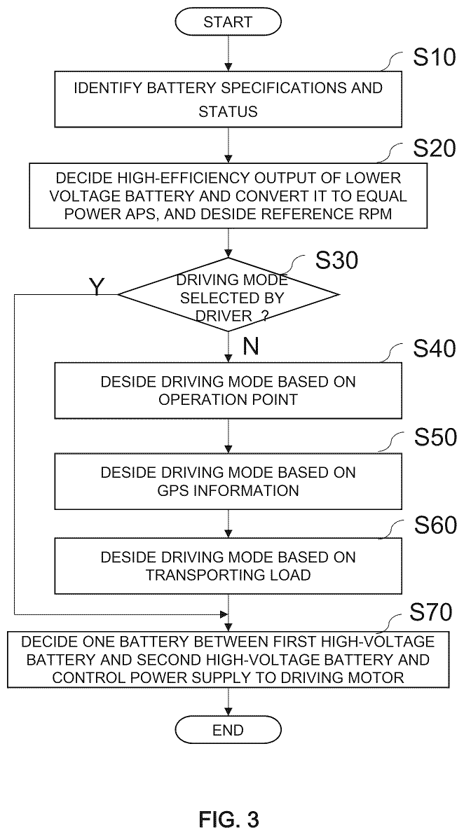

FIG. 3 is a flow chart illustrating a control process, and the description thereof will be detailed below.

A control process of a battery may be performed under the control of the first controller Ctrl 1, but the present disclosure is not limited thereto.

The first controller Ctrl 1 may include a processor such as a memory. The memory may store computer programs for battery use control, and if necessary, various data for the control process. The processor may execute the programs stored in the memory, and the first controller Ctrl 1 may perform battery use control according to the programs.

Referring to FIG. 3, at step S10, the first controller Ctrl 1 may identify the specifications and status of the first high-voltage battery MB and/or the second high-voltage battery SB.

The battery specifications may include at least one of a C-rate, a nominal voltage, an efficiency, a maximum current, a system voltage, and a continuous output, and the battery status may include at least one of a State of Health (SOH), a SOC, a voltage, and a temperature.

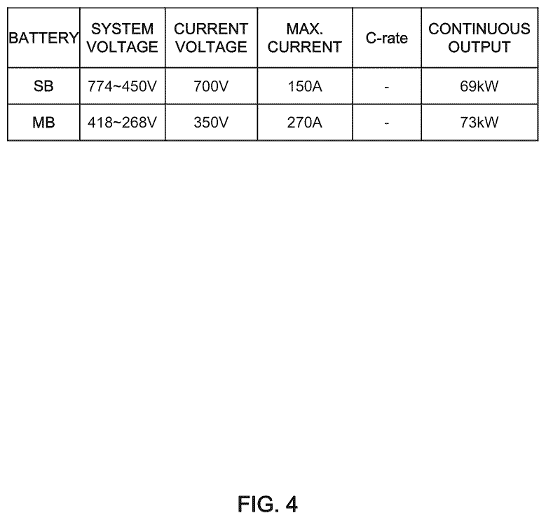

FIG. 4 is an exemplary view illustrating the specifications of the first high-voltage battery MB and the second high-voltage battery SB.

FIG. 4 illustrates that the first high-voltage battery MB is a battery of a lower voltage than the second high-voltage battery SB, but the present disclosure is not limited thereto.

The first controller Ctrl 1 may determine that the first high-voltage battery MB is a lower-voltage battery based on the specifications of the first high-voltage battery MB and the second high-voltage battery SB.

The first controller Ctrl 1, at step S20, may determine a lower voltage battery between the first high-voltage battery MB and the second high-voltage battery SB, i.e. the high-efficiency output, an accelerator pedal sensor (APS) conversion value, and a standard RPM.

For example, the memory may store high-efficiency output data for each battery specification. The first controller Ctrl 1 may select the data matched with the specification of the first high-voltage battery MB and determine the high efficiency output.

The first controller Ctrl 1 may convert the high-efficiency output into the APS value.

For example, the required APS value determined according to how hard the driver pushes the acceleration pedal, may be predetermined and output as the required output of the first driving motor M through the equation stored in the memory. The first controller Ctrl 1 may convert the high-efficiency output into the APS value by using the equation.

The first controller Ctrl 1 may determine a reference RPM for the RPM reference line based on a torque-RPM map (also referred to as a torque-to-RPM map) for the first driving motor M.

For example, the RPM at the point where the maximum torque line and the maximum output line meet in the torque-RPM map may be determined as the reference RPM.

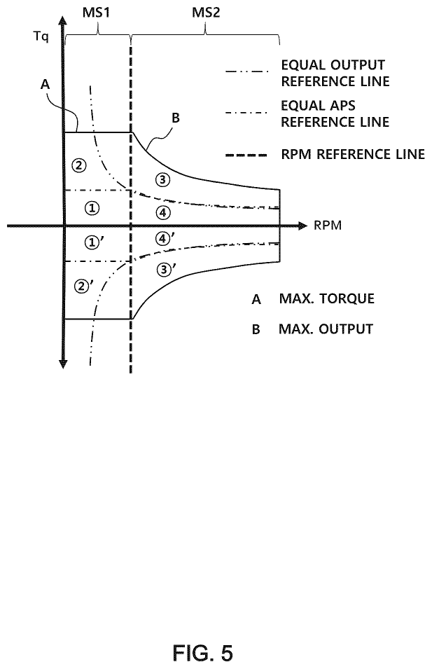

For example, as shown in FIG. 5, the RPM at the point where the maximum torque line A and the maximum output line B meet in the torque-RPM map may be determined as the reference RPM.

At step S30, the first controller Ctrl 1 may identify whether one of the plurality of driving modes is selected by the user.

Selection the driving mode by the driver may be performed by the input of the driver through the AVN screen or by input means such as a button, a jogstick, or a dial provided in the first mobility MLT 1.

For example, the plurality of driving modes may include a first driving mode and a second driving mode.

The first driving mode may include a low-output mode (or a normal mode), and the second driving mode may include a high-torque mode (or a function mode).

The low-power mode may include at least one of Normal Mode, Comfort Mode, Eco Mode, and Smart Mode, and the high-torque mode may include at least one of Sports Mode and Track Mode.

The normal mode may be, as an example, a normal driving mode that maintains a balance between vehicle performance and fuel efficiency.

The comfort mode may be, as an example, a mode that provides comfort to the driver such as acceleration, braking, and riding quality.

The eco-mode may be, as an example, a mode for optimizing the fuel efficiency of the vehicle. In eco-mode, acceleration may be slow and the transmission gear ratio may become higher, allowing energy consumption to be relatively reduced. The eco-mode may include a control function that reduces the amount of electricity usage by automatically turning off an air conditioning device.

The sports mode may be, as an example, a mode for maximizing vehicle performance. In sports mode, the output of the first driving motor M may be increased and the transmission gear ratio may be lowered, allowing the vehicle to accelerate quickly. In addition, sports mode may include a control function in which steering assistance is increased and a suspension system becomes stronger, thereby allowing more agile driving.

The track mode may be a mode designed to be suitable for driving on a dedicated race track, for example, the mode supported in Tesla vehicles. The track mode may allow the change of settings such as stability control, traction control, regenerative braking, and cooling systems to improve performance and handling.

At step S30, if it is determined that the driving mode is selected, the process may proceed to step S70, which will be described below.

At step S30, if it is determined that the driving mode is not selected, the first controller Ctrl 1 may determine a driving mode based on the operation point at step S40.

The first controller Ctrl 1 may determine one of the plurality of operation areas based on the operation point of the first driving motor M. Each operation point may represent an operational characteristic (e.g., a torque-RPM relationship) of the first driving motor M.

FIG. 5 is an exemplary view illustrating a plurality of operation areas divided on the torque-RPM map, and the description thereof will be detailed below.

First, as shown in FIG. 5, the plurality of operation areas may be divided into a first operation area \textcircled{1} (also referred to as a first area), a second operation area \textcircled{2} (also referred to as a second area), a third operation area \textcircled{3} (also referred to as a third area), and a fourth operation area \textcircled{4} (also referred to as a fourth area). By an equal output reference line, an equal APS reference line, and an RPM reference line.

The equal output reference line may be an equal output line on the torque-RPM map for the high-efficiency output of the first high-voltage battery MB.

In addition, the equal APS reference line may be an equal APS line for the APS value converted corresponding to the high-efficiency output.

The RPM reference line may be the reference RPM line described above. The reference RPM may be the boundary between the equal torque section and the equal output section in the map of FIG. 5.

Referring to FIG. 5, the first operation area \textcircled{1} may be an area below the RPM reference line and the equal APS reference line, the second operation area \textcircled{2} may be an area surrounded by the equal output reference line, the equal APS reference line, and the set maximum torque line, the third operation area \textcircled{3} may be an area exceeding the equal output reference line, and the fourth operation area \textcircled{4} may be an area exceeding the RPM reference line and below the equal output reference line. In other words, the first area \textcircled{1} may be associated with RPM values below the RPM reference line and torque values below the equal APS reference line, the second area \textcircled{2} may be associated with torque values above the equal APS reference line and below the equal output reference line and a maximum torque line, the third area \textcircled{3} may be associated with torque values above the equal output reference line, and the fourth area \textcircled{4} may be associated with RPM values above the RPM reference line and torque values below the equal output reference line.

In FIG. 5, the torque area below zero (0) may be for the regenerative braking situation by the first driving motor M. Similarly, the area may be divided into four (4) operation areas by the equal output reference line, the equal APS reference line, and the RPM reference line.

In FIG. 5, the operation areas in the driving situation by the first driving motor M and the operation areas in the regenerative braking situation may be symmetrical with respect to the RPM axis.

The first driving mode may be set as a default driving mode.

Without the driver selection and the decision on the driving mode or at the beginning of driving, the driving mode may be set to the first driving mode.

The first controller Ctrl 1, if the operation point of the first driving motor M changes from the second operation area \textcircled{2} to the third operation area \textcircled{3}, may change the driving mode to the second driving mode.

In the driving situation of the first driving motor M (i.e., in a situation where the torque is positive in the map of FIG. 5), if the requested APS value of the driver is a high-speed sudden acceleration situation or a long uphill driving situation, the operation point may be changed from the second operation area \textcircled{2} to the third operation area \textcircled{3} and the driving mode may be determined as the second driving mode.

In the regenerative braking situation of the first driving motor M (i.e., in a situation where the torque is negative in the map of FIG. 5), if the requested Brake Pedal Sensor (BPS) value of the driver is a steep slope driving situation on a mountain road, the operation point may be changed from the second operation area \textcircled{2} to the third operation area \textcircled{3} and the driving mode may be determined as the second driving mode.

The first controller Ctrl 1 may determine the driving mode as the second driving mode if the operation point changes from the third operation area \textcircled{3} to the second operation area \textcircled{2}.

In the driving situation of the first driving motor M, if the requested APS value of the driver is a steep uphill situation on a mountain road, the operation point may be changed from the third operation area \textcircled{3} to the second operation area \textcircled{2}. The driving mode may be determined as the second driving mode.

In the regenerative braking situation of the first driving motor M, if the requested BPS value of the driver is a high-speed sudden deceleration situation, the operation point may be changed from the third operation area \textcircled{2} to the second operation area \textcircled{2}. The driving mode may be determined as the second driving mode.

If the operation point is changed from the second operation area \textcircled{2} to the first operation area \textcircled{1}, the driving mode may be determined as the first driving mode.

If the required APS value indicates a sudden acceleration driving situation in the city or the required BPS value indicates a sudden deceleration driving situation in the city, the operation point may be changed from the second operation area \textcircled{2} to the first operation area \textcircled{1}, and the driving mode may be determined as the first driving mode.

The first controller Ctrl 1 may determine the driving mode as the second driving mode if maintained within the second operation area \textcircled{2} for longer than a set time (e.g., a threshold time duration), for example, more than 5 seconds.

For example, if the required APS value indicates a mountain road uphill driving situation or the required BPS value indicates a mountain road downhill driving situation, the operation point may be maintained in the second operation area \textcircled{2}, and the driving mode may be determined as the first driving mode.

The operation point of the first driving motor M may be determined based on the current torque and current RPM of the first driving motor M or based on the required APS value due to the pressing of the accelerator pedal by the driver.

The first controller Ctrl 1 may determine the driving mode based on the Global Positioning System (GPS) location at step S50.

For example, the first controller Ctrl 1, in the case of a mountain road driving situation, based on the location of the first mobility MLT 1 acquired through a GPS receiver, may determine the driving mode as the second driving mode.

Based on the location, in the case of driving on city roads, general roads, or highways, the driving mode may be determined as the first driving mode.

The first controller Ctrl 1 may determine the driving mode according to the transporting load of the first mobility MLT 1 at step S60.

For example, if the first mobility MLT 1 is towing the second mobility MLT 2 or another vehicle, and the transporting load is greater than or equal to a predetermined load (e.g., a threshold value), the driving mode may be determined as the second driving mode.

After the driving mode is determined, the first controller Ctrl 1 may determine one of the first high-voltage battery MB and the second high-voltage battery SB at step S70, and control to supply power to the first driving motor M.

After the operation point of the first driving motor M is located within the second operation area \textcircled{2} and the driving mode is the first driving mode, the first controller Ctrl 1 may select the first high-voltage battery MB which is a lower-voltage battery between the first high-voltage battery MB and the second high-voltage battery SB to use for supply power to the first driving motor M.

For example, if the operation point is located within the second operation area \textcircled{2} and the driving mode is the second driving mode, the first controller Ctrl 1 may select the second high-voltage battery SB to use for supply power to the first driving motor M.

If the operation point is located within the fourth operation area \textcircled{4} and the driving mode is the first driving mode, the second high-voltage battery (SB) may be used.

If the operation point is located within the fourth operation area \textcircled{4} and the driving mode is the second driving mode, the first high-voltage battery MB may be used.

If the operation point is located within the first operation area \textcircled{1}, the first high-voltage battery MB may be used regardless of the driving mode, and if the operation point is located within the third operation area \textcircled{3}, the second high-voltage battery SB may be used regardless of the driving mode.

The first controller Ctrl 1 may determine that the second high-voltage battery SB is connected and added to the power system of the first mobility MLT 1.

The second high-voltage battery SB may be detachably connected, but the present disclosure is not limited thereto. The control process may also be applied if the second high-voltage battery SB is fixedly placed in the first mobility MLT 1.

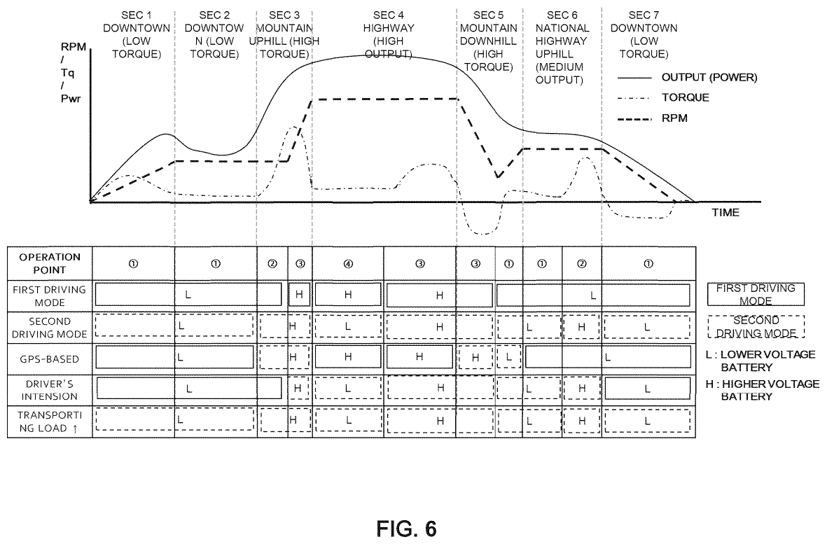

FIG. 6 is an exemplary view illustrating a driving simulation, and the description thereof will be detailed below.

The upper graph in FIG. 6 illustrates the RPM, the torque, and the power of the first driving motor M according to driving times. The lower graph in FIG. 6 illustrates the driving mode and the battery for each driving section. The ‘low-voltage battery’ may be the first high-voltage battery MB and the ‘high-voltage battery’ may be the second high-voltage battery SB in FIG. 6.

Referring to FIG. 6, the first mobility MLT 1 may drive from a first driving section SEC 1 to a seventh driving section SEC 7. The first driving section SEC 1 may be a low-torque driving situation on city roads, and a second driving section SEC 2 may be a low-output driving situation on city roads.

In FIG. 6, a third driving section SEC 3 may be a high-torque driving situation as a mountain road uphill driving situation, and a fourth driving section SEC 4 may be a highway driving situation which is a high-output driving situation.

The fourth driving section SEC 4 may be a high-torque regenerative braking situation as a mountain road uphill driving situation, and a sixth driving section SEC 6 may be a medium-power output driving situation as a national road uphill driving situation.

The seventh driving section SEC 7 may be a low-torque driving situation on city roads.

In the above-described driving situation, the operation points in the first driving section SEC 1 and the second driving section SEC 2 may correspond to the first operation area \textcircled{1} and the operation point in the third driving section SEC 3 may be the second operation area \textcircled{2} in the first half, and the third operation area \textcircled{3} in the second half.

The operation point in the fourth driving section SEC 4 may be the fourth operation area \textcircled{4} in the first half, and the third operation area \textcircled{3} in the second half.

The operation point in the fifth driving section SEC 5 may be the third operation area \textcircled{3} in the first half, and the first operation area \textcircled{1} in the second half.

The operation point in the sixth driving section SEC 6 may be the first operation area \textcircled{1} in the first half, and the second operation area \textcircled{2} in the second half.

The operation point in the seventh driving section SEC 7 may be the first operation area \textcircled{1}.

If the driver selects the driving mode as the first driving mode, as shown in FIG. 6, power may be supplied to the first driving motor M by using the first high-voltage battery MB in the first driving section SEC 1, the second driving section SEC 2, and the first half of the third driving section SEC 3. The power may be supplied to the first driving motor M by using the second high-voltage battery SB in the second half of the third driving section SEC 3 and the fourth driving section SEC 4.

The regenerative braking power generated in the first driving motor M may be controlled to charge the second high-voltage battery SB in the first half of the fifth driving section SEC 5, and controlled to supply power to the first driving motor M by using the first high-voltage battery MB in the second half of the fifth driving section SEC 5.

The power may be supplied to the first driving motor M by using the first high-voltage battery MB in the sixth driving section SEC 6.

The regenerative braking power generated in the seventh driving section SEC7 may be controlled to charge the first high-voltage battery MB.

If the second driving mode is selected by the driver, the first high-voltage battery MB may be used in the first driving section SEC1 and the second driving section SEC2, and the second high-voltage battery SB may be used in the third driving section SEC3.

The first high-voltage battery MB may be used in the first half of the fourth driving section SEC 4 and the second high-voltage battery SB may be used in the second half of the fourth driving section SEC 4.

The regenerative braking power generated in the fifth driving section SEC 5 may be controlled to charge the second high-voltage battery SB in the first half and supply power to the first driving motor M by using the first high-voltage battery MB.

The first high-voltage battery MB may be used in the first half of the sixth driving section SEC 6, and the second high-voltage battery SB may be used in the second half of the sixth driving section SEC 6.

The power generated in the seventh driving section SEC 7 may be used for charging the first high-voltage battery MB.

A case in which the driving mode is determined based on the GPS location will be described below.

The driving mode in the first driving section SEC 1 and the second driving section SEC 2 may be determined as the first driving mode, and the first high-voltage battery MB may be used.

The driving mode in the third driving section SEC 3 may be determined as the second driving mode, and the second high-voltage battery SB may be used.

The driving mode in the fourth driving section SEC 4 may be determined as the first driving mode, and the second high-voltage battery SB may be used.

The driving mode in the fifth driving section SEC 5 may be determined as the second driving mode. The second high-voltage battery SB may be used in the first half, and the first high-voltage battery MB may be used in the second half of the fifth driving section S.

The driving mode in the sixth driving section SEC 6 and the seventh driving section SEC 7 may be determined as the second driving mode, and the battery to be used may be the first high-voltage battery MB.

A case in which the driving mode is determined based on the intention of the driver, i.e. the operation point.

The driving mode in the first driving section SEC 1 and the second driving section SEC 2 may be determined as the first driving mode, and the battery to be used may be the first high-voltage battery MB.

The driving mode in the first half of the third driving section SEC 3 may be determined as the first driving mode and the first high-voltage battery MB may be used. The driving mode in the second half of the third driving section SEC 3 may be determined as the second driving mode, and the second high-voltage battery SB may be used.

The driving mode in the fourth driving section SEC 4 may be determined as the second driving mode. The first high-voltage battery MB may be used in the first half of the fourth driving section SEC 4, and the second high-voltage battery SB may be used in the second half of the fourth driving section SEC 4.

The driving mode in the fifth driving section SEC 5 may be determined as the second driving mode. The regenerative braking power may be charged by using the second high-voltage battery SB in the first half of the fifth driving section SEC 5, and the power may be supplied to the first driving motor M by using the first high-voltage battery MB in the second half of the fifth driving section SEC 5.

The driving mode in the sixth driving section SEC 6 may be the second driving mode. The first high-voltage battery MB may be used in the first half of the sixth driving section SEC 6, and the second high-voltage battery SB may be used in the second half of the sixth driving section SEC 6.

The driving mode in the seventh driving section SEC 7 may be determined as the first driving mode, and the regenerative braking power may be charged by using the first high-voltage battery MB.

A case in which the driving mode is determined if the transporting load is greater than the set load.

Since the transporting load is greater than the set load, the driving mode may be determined as the second driving mode in the entire driving section.

The first high-voltage battery MB may be used to supply power to the first driving motor M in the first driving section SEC 1 and the second driving section SEC 2, and the second high-voltage battery SB may be used in the third driving section SEC 3.

The first high-voltage battery MB may be used in the first half of the fourth driving section SEC 4, and the second high-voltage battery SB may be used in the second half of the fourth driving section SEC 4.

The regenerative braking power may be charged by using the second high-voltage battery SB in the first half of the fifth driving section SEC 5, and the power may be supplied to the first driving motor M by using the first high-voltage battery MB in the second half of the fifth driving section SEC 5.

The first high-voltage battery MB may be used in the first half of the sixth driving section SEC 6, and the second high-voltage battery SB may be used in the second half of the sixth driving section SEC 6.

The regenerative braking power generated in the seventh driving section SEC7 may be charged with the first high-voltage battery MB.

A method of controlling a battery in a mobility apparatus may include a plurality of wheels, a driving motor for supplying a driving force to the plurality of wheels, and a controller for controlling power supply to the driving motor, the method comprising determining, by the controller, one driving mode among a plurality of driving modes, determining, by the controller, one battery between a first battery and a second battery based on an operation point of the driving motor and the determined driving mode, and controlling, by the controller, the power supply to the driving motor by using the determined battery.

The determining the one battery comprises determining an operation area in which the operation point is included among a plurality of operation areas based on a torque-RPM map of the driving motor.

The plurality of operation areas may be set according to at least one of an equal output reference line, an equal APS reference line, or an RPM reference line.

The equal output reference line may be set based on an efficiency of a lower voltage battery between the first battery and the second battery.

The RPM reference line may be based on a boundary between an equal torque section and an equal output section in the torque-RPM map.

The plurality of operation areas may include at least two or more of a first operation area set below the RPM reference line and the equal APS reference line, a second operation area set as surrounded by the equal output reference line, the equal APS reference line, and a set maximum torque line, a third operation area set as exceeding the equal output reference line, and a fourth operation area set as exceeding the RPM reference line and below the equal output reference line.

The plurality of driving modes may include a first driving mode and a second driving mode, and wherein determining the one battery includes, in response to the operation point being within the second operation area, and the determined driving mode being the first driving mode, determining a lower voltage battery between the first battery and the second battery as the one battery, in response to the operation point being within the second operation area, and the determined driving mode being the second driving mode, determining a higher voltage battery between the first battery and the second battery as the one battery, in response to the operation point being within the fourth operation area, and the determined driving mode being the first driving mode, determining a higher voltage battery between the first battery and the second battery as the one battery, and in response to the operation point being within the fourth operation area, and the determined driving mode being the second driving mode, determining a lower voltage battery between the first battery and the second battery as the one battery,

The determining of the one battery may include at least one of in response to the operation point being within the first operation area, determining a lower voltage battery between the first battery and the second battery as the one battery, and in response to the operation point being within the third operation area, determining a higher voltage battery between the first battery and the second battery as the one battery.

The first driving mode may include a low-output mode, and the second driving mode includes a high-torque mode.

The low-output mode may include at least one of a normal mode, a comfort mode, or an eco mode, and the high-torque mode may include at least one of a sports mode or a track mode.

The determining of the one driving mode may include at least one of determining a driving mode set as a default between a first driving mode and a second driving mode as the one driving mode, in response to the operation point being changed from the second operation area to the third operation area, determining the second driving mode as the one driving mode, in response to the operation point being changed from the third operation area to the second operation area, determining the second driving mode as the one driving mode, in response to the operation point being changed from the second operation area to the first operation area, determining the first driving mode as the one driving mode, and in response to the operation point maintained in the second operation area for a time period equal to or greater than a set period, determining the second driving mode as the one driving mode.

The determining of the one driving mode may further include determining one among the first driving mode and the second driving mode according to a location of the mobility apparatus.

The determining the one among the first driving mode and the second driving mode may include in response to the location being a mountain road, determining the second driving mode as the one driving mode, and in response to the location being at least one of a city road, a general road, or a highway, determining the first driving mode as the one driving mode.

The determining the one driving mode may include determining one among the first driving mode and the second driving mode according to a transporting load of the mobility apparatus.

The determining the one among the first driving mode and the second driving mode may include in response to the mobility apparatus towing another apparatus, and the transporting load being equal to or greater than a setting load, determining the second driving mode as the one driving mode.

The determining the one driving mode may include determining one among the plurality of driving modes according to a selection of a driver.

The determining of the one battery may include determining that the second battery is detachably connected and added to a power system including the first battery.

The driving motor may be configured to generate a regenerative braking power, and the method may further comprise controlling to charge the regenerative braking power to the determined battery.

A mobility apparatus may include a plurality of wheels, a driving motor configured to supply power to the plurality of wheels, and a controller configured to control power supply to the driving motor, wherein the controller includes a memory for storing instructions and at least one or more processors configured to execute the instructions, and wherein the instructions cause, when executed by the processor, the controller to determine one driving mode among a plurality of driving modes, determine one battery between a first battery and a second battery based on an operation point of the driving motor and the determined driving mode, and control the power supply for the driving motor using the determined battery.

The second battery may be detachably connected to the mobility apparatus, and the instructions may further cause the controller to determine the one battery after determining the second battery is connected and added to a power system including the first battery.

What is claimed is:

1. A method performed by an apparatus of a vehicle, the method comprising:
selecting, by a controller of the vehicle, a driving mode, among a plurality of driving modes, for the vehicle;
based on an operational characteristic of a driving motor of the vehicle and based on the selected driving mode, selecting a battery between a first battery of the vehicle and a second battery of the vehicle, wherein the driving motor supplies a driving force to a plurality of wheels of the vehicle; and
controlling, by the controller, the selected battery to supply power to the driving motor.

2. The method of claim 1, wherein the operational characteristic of the driving motor maps to an area, of a plurality of areas, on a torque-to-revolutions per minute (RPM) map associated with the driving motor, and
wherein the selecting of the battery comprises:
selecting the battery based on the area to which the operational characteristic of the driving motor is mapped on the torque-to-RPM map.

3. The method of claim 2, wherein the plurality of areas on the torque-to-RPM map are set based on at least one of an equal output reference line, an equal accelerator pedal sensor (APS) reference line, or an RPM reference line.

4. The method of claim 3, wherein the equal output reference line is set based on efficiency of a lower voltage battery of the first battery and the second battery.

5. The method of claim 3, wherein the RPM reference line is based on a boundary between an equal torque section in the torque-to-RPM map and an equal output section in the torque-to-RPM map.

6. The method of claim 3, wherein the plurality of areas on the torque-to-RPM map comprises at least two or more of:
a first area associated with RPM values below the RPM reference line and torque values below the equal APS reference line,
a second area associated with torque values above the equal APS reference line and below the equal output reference line and a maximum torque line,
a third area associated with torque values above the equal output reference line, and
a fourth area associated with RPM values above the RPM reference line and torque values below the equal output reference line.

7. The method of claim 6, wherein the plurality of driving modes comprise a first driving mode and a second driving mode, and
wherein the selecting of the battery further comprises one of:
based on the operational characteristic being associated with the second area on the torque-to-RPM map, and based on the selected driving mode being the first driving mode, selecting the battery by selecting a lower voltage battery of the first battery and the second battery;
based on the operational characteristic being associated with the second area on the torque-to-RPM map, and based on the selected driving mode being the second driving mode, selecting the battery by selecting a higher voltage battery of the first battery and the second battery;
based on the operational characteristic being associated with the fourth area on the torque-to-RPM map, and based on the selected driving mode being the first driving mode, selecting the battery by selecting a higher voltage battery of the first battery and the second battery; or
based on the operational characteristic being associated with the fourth area on the torque-to-RPM map, and based on the selected driving mode being the second driving mode, selecting the battery by selecting a lower voltage battery of the first battery and the second battery.

8. The method of claim 6, wherein the plurality of driving modes comprise a first driving mode and a second driving mode, and
wherein selecting of the battery further comprises at least one of:
based on the operational characteristic being associated with the first area on the torque-to-RPM map, selecting the battery by selecting a lower voltage battery of the first battery and the second battery; or
based on the operational characteristic being associated with the third area on the torque-to-RPM map, selecting the battery by selecting a higher voltage battery of the first battery and the second battery.

9. The method of claim 1, wherein the plurality of driving modes comprise a low-output mode and a high-torque mode.

10. The method of claim 9, wherein the low-output mode comprises at least one of a normal mode, a comfort mode, or an eco mode, and
wherein the high-torque mode comprises at least one of a sports mode or a track mode.

11. The method of claim 6, wherein the selecting of the driving mode comprises at least one of:
selecting, between a first driving mode and a second driving mode, a default driving mode;
based on the operational characteristic changing from being associated with the second area to being associated with the third area, selecting the second driving mode;
based on the operational characteristic changing from being associated with the third area to being associated with the second area, selecting the second driving mode;
based on the operational characteristic changing from being associated with the second area to being associated with the first area, selecting the first driving mode; or
based on the operational characteristic being associated with the second area for longer than a threshold time duration, selecting the second driving mode.

12. The method of claim 1, wherein the selecting of the driving mode comprises:
selecting, based on a location of the vehicle, one of a first driving mode or a second driving mode.

13. The method of claim 12, wherein the selecting of the driving mode further comprises:
based on the location being a mountain road, selecting the second driving mode; and
based on the location being at least one of a city road, or a highway, selecting the first driving mode.

14. The method of claim 1, wherein the selecting of the driving mode comprises:
selecting, based on a transporting load of the vehicle, one of a first driving mode or a second driving mode.

15. The method of claim 14, wherein the selecting of the driving mode further comprises:
based on the vehicle towing a second vehicle and the transporting load being greater than or equal to a threshold value, selecting the second driving mode.

16. The method of claim 1, wherein the selecting of the driving mode comprises:
selecting the driving mode based on a user input of a driver of the vehicle.

17. The method of claim 1, wherein the selecting of the battery comprises:
determining that the second battery is detachably connected to a power system of the vehicle, the power system comprising the first battery.

18. The method of claim 1, wherein the driving motor is configured to generate a regenerative braking power, and
wherein the method further comprises controlling the vehicle to charge the selected battery with the regenerative braking power.

19. A vehicle comprising:
a plurality of wheels;
a driving motor configured to drive the plurality of wheels; and
a controller comprising:
memory storing instructions; and
one or more processors configured to execute the instructions, and
wherein the instructions, when executed by the one or more processors, cause the controller to:
select, among a plurality of driving modes, a driving mode for the vehicle;
based on an operational characteristic of the driving motor and based on the selected driving mode, select, between a first battery and a second battery, a battery; and
control the selected battery to supply power to the driving motor.

20. The vehicle of claim 19, wherein the second battery is detachably connected to a power system of the vehicle; and
wherein the instructions, when executed by the one or more processors, further cause the controller to select the battery by:
selecting the battery after determining that the second battery is connected to the power system, wherein the power system comprises the first battery.
